(19) United States
(12) Patent Application Publication
(10) Pub. No.: US 2020/0291850 A1
(43) Pub. Date: Sep. 17, 2020

(54) WASTEGATE ASSEMBLY FOR A TURBOCHARGER

(71) Applicants: ElringKlinger AG, Dettingen (DE); Continental Automotive GmbH, Hannover (DE)

(72) Inventors: Christian ROEMER, Kleinniedesheim (DE); Christian KIRSCHNER, Neulussheim (DE); Markus PFLUEGER, Eurasburg (DE); Maximilian HOFFMANN, Eurasburg (DE)

(73) Assignees: ElringKlinger AG, Dettingen (DE); Continental Automotive GmbH, Hannover (DE)

(21) Appl. No.: 16/767,678

(22) PCT Filed: Dec. 4, 2018
(86) PCT No.: PCT/EP2018/083469

§ 371 Date: May 28, 2020

(30) Foreign Application Priority Data
Dec. 5, 2017 (DE) 10 2017 128 830.9

(51) Int. Cl. F02B 37/18; F16K 1/20

(52) U.S. Cl. CPC F02B 37/186; F16K 1/2035; F16K 1/2078

(57) ABSTRACT

A wastegate assembly for a turbocharger having a turbine casing has a wastegate flap, a wastegate flap lever, a wastegate spindle and a bearing bush for the wastegate spindle. In addition, the wastegate assembly has a sealing unit formed from a soft-material volume sealing ring and a diaphragm spring that contacts the volume sealing ring.

The invention relates to a wastegate assembly for an exhaust gas turbocharger.

An exhaust gas turbocharger usually comprises a turbine housing, a compressor housing and a bearing housing arranged between the turbine housing and the compressor housing. A turbine wheel which is secured on a shaft and driven by the exhaust gas flow of an internal combustion engine is provided in the turbine housing. The rotational movement of the shaft is transferred to a compressor impeller which is similarly secured on the shaft and which is arranged in the compressor housing. The shaft is rotatably mounted in the bearing housing.

In order to be able to rationally operate an exhaust gas turbocharger of that kind not only at high engine speeds, but also at low engine speeds it is necessary to regulate the exhaust gas mass flow flowing into the turbine housing.

It is known to perform such a regulation of the exhaust gas mass flow flowing into the turbine housing through use of a wastegate assembly. This wastegate assembly comprises, inter alia, a wastegate flap closing a wastegate channel, a wastegate spindle and a wastegate flap lever. The wastegate flap lever is a component of a linkage system of which, in addition, a regulating rod and an actuator are part. This linkage system allows adjustment of the wastegate flap in such a way that it is closed when smaller exhaust mass flows are present and open when larger exhaust gas mass flows are present. Consequently, when smaller exhaust gas mass flows are present the entire exhaust gas mass flow is supplied to the turbine wheel and drives this. When larger exhaust gas mass flows are present a part of the exhaust gas mass flow is conducted past the turbine wheel via the wastegate channel and thus bypasses the turbine wheel.

A regulating flap arrangement of an exhaust gas turbocharger is known from DE 10 2009 030 520 A1. This regulating flap arrangement comprises a flap plate, a flap shaft guided by means of a bush in the turbine housing and a sealing device for sealing the flap shaft at at least one sealing point. The flap shaft is connected with a regulating rod of a drive by way of an outer flap lever and with the flap plate by way of an inner flap lever. The sealing device comprises at least one resilient sealing lip which presses under bias on the sealing point.

An actuating device for an exhaust gas flow control element of an exhaust gas turbocharger, which device can be a wastegate assembly, is known from DE 20 2011 109 832 U1. This wastegate assembly comprises a wastegate spindle which is guided in a bush and which is connected with a spindle setting element. A sheet-metal ring having resilient properties is provided as seal in the transition region between the wastegate spindle and the spindle setting shaft. This sheet-metal ring is of plate-shaped construction and has a central opening, an inner ring region and an outer ring region, the inner ring region being connected with the outer ring region by a middle ring region. The inner and outer ring regions are formed to be flat and lie in planes which are perpendicular with respect to the axis of symmetry and are offset in axial direction relative to one another, whereas the middle ring region in section along the axis extends at an inclination with respect to the two other ring regions.

The wastegate spindle of a wastegate assembly is—as explained in the foregoing—usually mounted in a bearing bush which is pressed into the turbine housing. Since in operation of the exhaust gas turbocharger the wastegate spindle heats up more rapidly than the bearing bush it is possible for jamming of the wastegate spindle within the bearing bush to occur. In order to avoid this jamming, compensation for the thermal expansion of the wastegate spindle can be provided by way of a larger diameter of the bearing bush by comparison with the diameter of the wastegate spindle. Due to the resulting gap dimension it is possible in operation of the exhaust gas turbocharger for a part of the exhaust gas mass flow to escape in undesired manner from the turbine housing into the environment of the exhaust gas turbocharger through a leakage gap between the bearing bush and the wastegate spindle.

A shaft sealing system for a turbocharger is known from WO 2013/0173055 A1. In this shaft sealing system use is made of a spring-mounted self-centring complementary pair of mutually opposite sealing surfaces for sealing a leakage gap between the shaft and the bearing bush. In that case, these sealing surfaces are pressed together by the force of the spring in order to achieve the desired sealing.

A shaft device of a turbocharger is known from DE 10 2008 057 207 A1, wherein the shaft device comprises a shaft arranged in a bearing bush device and wherein the bearing bush device has at one end or both ends a receptacle for a sealing device which sealingly bears in radial direction against a respective sealing surface.

The object of the invention consists of indicating a wastegate assembly in which this escape of part of the exhaust gas mass flow through the leakage gap between the bearing bush and the wastegate spindle into the environment is avoided.

This object is fulfilled by a wastegate assembly with the features indicated in claim 1. Advantageous embodiments and developments of the invention are indicated in the dependent claims.

A wastegate assembly according to the invention comprises a wastegate flap, a wastegate flap lever, a wastegate spindle and a bearing bush for the wastegate spindle. Moreover, it includes a sealing unit which is formed by a volumetric sealing ring of soft material and a plate spring in contacted with the volumetric sealing ring.

The bearing bush preferably has a widening section into which the volumetric sealing ring is inserted.

The volumetric sealing ring consists of soft material, preferably graphite or mica, in which one or more support layers, for example steel strips, are layered. The plate spring consists of a material with high temperature resistance, which is constructed to be resistant to, for example, temperatures above 300° C., preferably temperatures above 500° C., and preferably consists of steels with an Ni content of 6.0 to 13.0%, a Cr content of 13 to 21%, a C content below 2% and an Mn content below 2%, or is made of materials with an Ni content of above 50%, a Cr content of 17 to 22%, a Ti content of 0.5 to 2.0% and an Al content of above 0.5%. These materials are distinguished by the fact that the mechanical properties and the thermal resistance are still sufficiently retained for the spring function of the plate spring at high temperatures.

In advantageous manner the widening section of the bearing bush is arranged in the end region, which faces the wastegate flap lever, of the bearing bush. The plate spring is positioned between the volumetric sealing ring of soft material and the wastegate flap lever. The plate spring seals between the wastegate flap lever and the volumetric sealing ring of soft material and adjusts for the wear which arises in this sealing system over the service life.

The volumetric sealing ring of soft material is advantageously pressed into the widening section of the bearing bush so as to achieve the desired sealing action. This pressing-in of the volumetric sealing ring in the widening section takes place in axial direction, i.e. in the direction of the longitudinal axis of the wastegate spindle. A high force is exerted in radial direction on both the bearing bush and the wastegate spindle through this pressing into place in axial direction due to a high level of plastification of the material of the volumetric sealing ring. As a result, a radial bias which is maintained during operation of the exhaust gas turbocharger and amplifies the sealing effect of the volumetric sealing ring of soft material arises between the wastegate spindle and the bearing bush.

The invention is explained in the following by way of example with reference to the figures, in which:

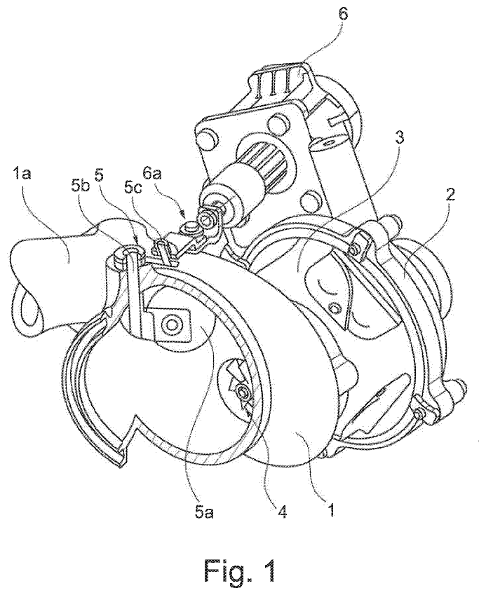

FIG. 1 shows a perspective diagram for illustration of the construction of an exhaust gas turbocharger equipped with a wastegate assembly,

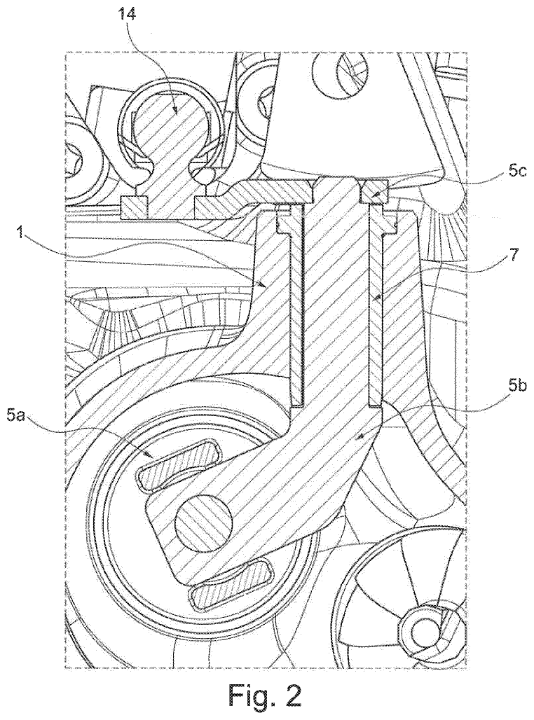

FIG. 2 shows a sectional view for illustration of a wastegate assembly,

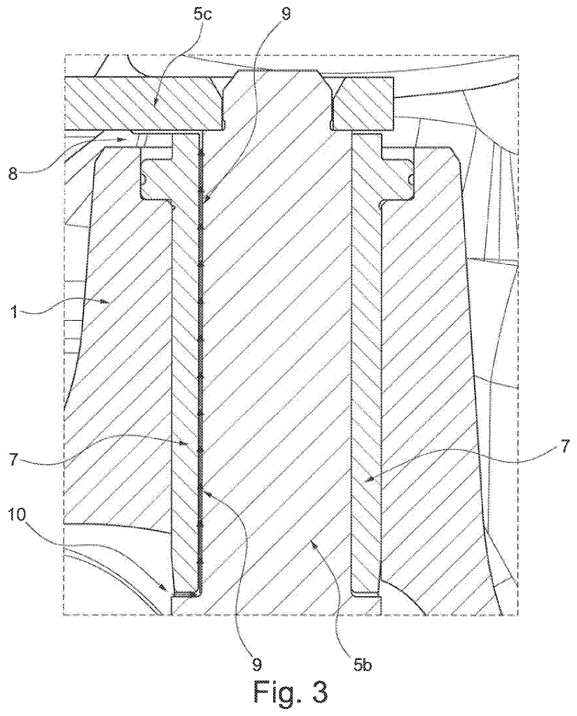

FIG. 3 shows a sectional view for illustration of the leakage path between the wastegate spindle and the bearing bush thereof,

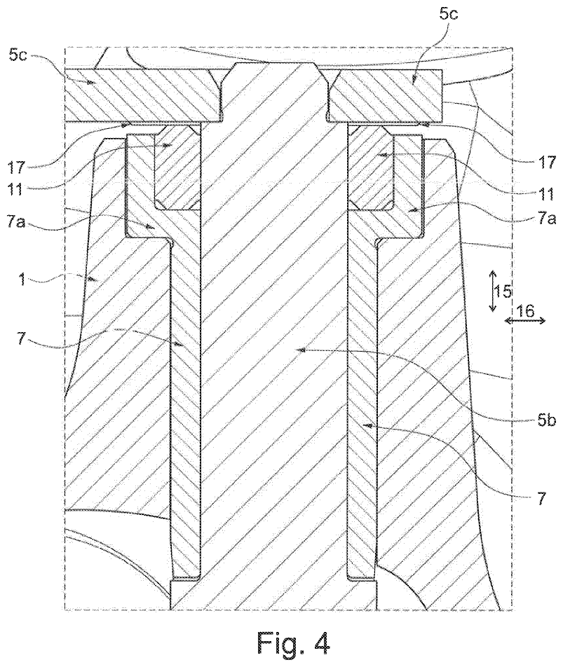

FIG. 4 shows a sectional view for illustration of a first embodiment of the invention,

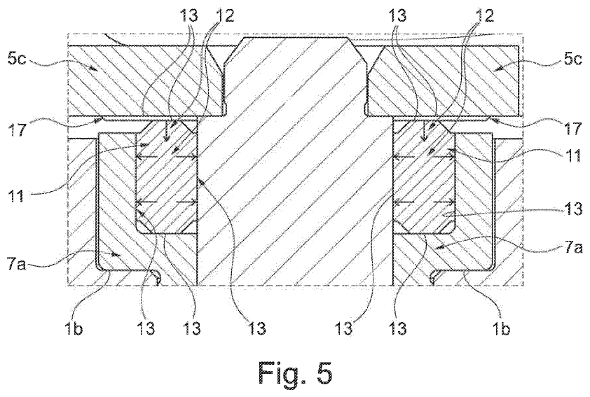

FIG. 5 shows an enlarged illustration of a sub-region of the sectional view shown in FIG. 4 and

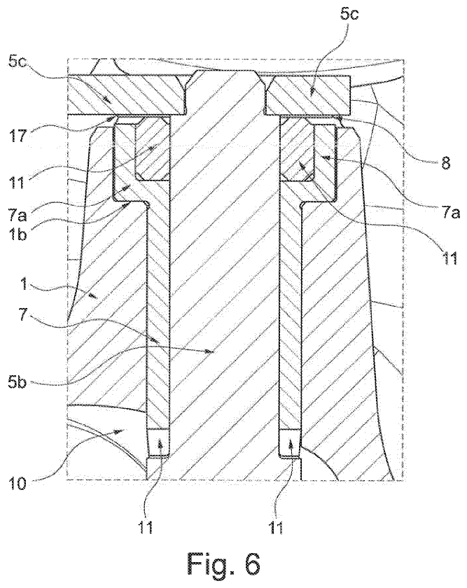

FIG. 6 shows a sectional view for illustration of a second embodiment of the invention.

FIG. 1 shows a perspective sketch for illustration of the construction of an exhaust gas turbocharger equipped with a wastegate assembly. This exhaust gas turbocharger comprises a turbine housing 1, a compressor housing 2 and a bearing housing 3 arranged between the turbine housing and the compressor housing. The turbine housing 1 is connected with the exhaust gas manifold 1 a of an internal combustion engine, by way of which a hot exhaust gas mass flow of the internal combustion engine is fed to the turbine wheel arranged in the turbine housing. The turbine wheel is driven or set into rotation by this hot exhaust gas mass flow. As a result, the shaft (not illustrated) of the exhaust gas turbocharger, on which the turbine wheel is arranged, is also set into rotation. This rotation of the shaft of the exhaust gas turbocharger is transferred to the compressor impeller arranged in the compressor housing 2 and similarly secured on the shaft of the exhaust gas turbocharger. Fresh air fed to the compressor is compressed through this rotation of the compressor impeller. This compressed fresh air is fed to the internal combustion engine so as to increase the power thereof. The shaft of the exhaust gas turbocharger is rotatably mounted in the bearing housing 3.

In addition, a wastegate assembly 5 is shown in FIG. 1. This is arranged in the turbine housing 1 and comprises a wastegate flap 5a which is actuable by way of a wastegate flap lever 5c and a wastegate spindle 5b and which is constructed for opening and closing a wastegate channel. The actuation or control of the wastegate flap takes place with use of an actuator 6 which is connected with the wastegate flap lever 5c by way of a setting element 6a.

As was already mentioned above, the wastegate spindle 5b is mounted in the turbine housing with use of a bearing bush, wherein this bearing bush is, for example, pressed into the turbine housing. This is illustrated in the following by way of FIG. 2, which shows a sectional view for depiction of a wastegate assembly. The wastegate assembly illustrated in FIG. 2 comprises a wastegate flap 5a which is connected with the wastegate flap lever 5c of a linkage system 14 by way of a wastegate spindle 5b. Moreover, a wastegate regulating rod, which is not illustrated in detail and by way of which the wastegate flap lever 5c is connected with an actuator (similarly not illustrated in detail), is part of this linkage system. The wastegate spindle 5b is, in FIG. 2, connected in its lower end region with the wastegate flap 5a and in its upper end region with the wastegate flap lever 5c. The wastegate spindle 5b is guided in the bearing bush 7, which is pressed into the turbine housing 1.

Since—as similarly already mentioned above—due to the heating up of the wastegate spindle 5b, which in operation of the exhaust gas turbocharger occurs more rapidly by comparison with the bearing bush 7, the diameter of the bearing bush is selected to be larger by comparison with the diameter of the wastegate spindle there is a leakage path 9 between the wastegate spindle 5b and the bearing bush 7 in most operating states of the exhaust gas turbocharger.

This is shown in FIG. 3, the subject of which is a sectional view for illustration of the leakage path 9 between the wastegate spindle 5b and the bearing bush 7. It is apparent from this sectional view this that leakage path 9 extends over the entire length of the bearing bush 7. It is connected in its lower end region with an exhaust gas chamber arranged behind the turbine wheel in flow direction. From this exhaust gas chamber 10 exhaust gas enters the leakage path 9, runs through this and is delivered in the upper end region of the bearing bush 7 in undesired manner to the environment 8 via an intermediate space between the bearing bush 7 and the wastegate flap lever 5c.

In order to prevent this, according to the present invention use is made of a seal which is formed by a volumetric sealing ring and a plate spring contacted by the volumetric sealing ring. By volumetric sealing ring there is understood a seal for high-temperature applications, which comprises a pressed sealing ring encircling a ring axis to be closed in an encircling direction and which is constructed to be resistant to high temperatures, for example temperatures above 300° C., preferably temperatures above 500° C. This volumetric sealing ring consists of soft material, preferably of graphite or mica, in which preferably one or more thin support layers, for example fabric layers, preferably steel strips or steel foils, are layered, which when the volumetric sealing ring is inserted are pressed together with the graphite or the mica at the sealing point of the ring.

FIG. 4 shows a sectional view for illustration of a first embodiment of the invention. In the case of this embodiment the wastegate spindle 5b is also guided in a bearing bush 7 pressed into the turbine housing 1. This bearing bush 7 has in its upper end region in FIG. 4 a widening section 7a surrounding the wastegate spindle 5b. A volumetric sealing ring of soft material 11, which preferably consists of graphite or mica, in which one or more support layers, for example thin steel strips, are layered, is inserted into this widening section 7a. This volumetric sealing ring 11 is inserted in FIG. 4 from above in axial direction into the widening section 7a of the bearing bush 7 when the wastegate assembly is assembled. Press-fitting of the volumetric sealing ring 11 into the widening section 7a of the bearing bush 7 takes place subsequently. After this press-fitting, a plate spring 17 is placed from above in axial direction on the volumetric sealing ring 11 and is used for biasing the volumetric sealing ring 11 in axial and radial directions. In that case, through the compacting of the volumetric sealing ring 11 in axial direction there is exerted, due to a high degree of plastification of the material of the volumetric sealing ring 11, a high level of force in radial direction 16 not only on the bearing bush 7, but also on the wastegate spindle 5b. A radial biasing between the bearing bush 7 and the wastegate spindle 5b, which is maintained over the operating service life of the wastegate assembly, thereby arises. By virtue of the press-fitting, which takes place in axial direction, of the volumetric sealing ring 11 in the widening region 7a of the bearing bush 7 and the thus-formed radial biasing between the bearing bush 7 and the wastegate spindle 5b the sealing action of the volumetric sealing ring 11 is increased in such a way that in operation of the exhaust gas turbocharger an undesired issue of exhaust gas, which is conducted through the leakage path 9, to the environment is effectively prevented.

FIG. 5 shows an illustration to enlarged scale of a sub-region of the sectional view shown in FIG. 4. The turbine housing 1, the widening section 7a of the bearing bush 7, the wastegate spindle 5b, the plate spring 17, the volumetric sealing ring 11 and the wastegate flap lever 5c are illustrated in this enlarged illustration. Moreover, the paths 12 of force and the sealing surfaces 13, which result during or through the insertion and compacting of the volumetric sealing ring 11 into and in the widening section 7a of the bearing bush, are illustrated in FIG. 5. Moreover, it is apparent from FIG. 5 that the turbine housing 1 has a receiving step 1 b for reception of the widening section 7a of the bearing bush.

FIG. 6 shows a sectional view for illustration of a second embodiment of the invention. This differs from the first embodiment shown in FIG. 4 merely in that a volumetric sealing ring 11 is also provided in the lower end region of the bearing bush 7. This further volumetric sealing ring increases the security that exhaust gas cannot be delivered from the exhaust gas chamber 10 via the leakage path 9 to the environment 8.

### REFERENCE NUMERAL LIST

1 turbine housing

1a exhaust gas manifold

1b receiving step

2 compressor housing

3 bearing housing

4 turbocharger impeller

5 wastegate assembly

5a wastegate flap

5b wastegate spindle

5c wastegate flap lever

6 actuator

6a setting element

7 bearing bush

7a widening section

8 environment

9 leakage path

10 exhaust gas chamber

11 volumetric sealing ring

12 paths of force

13 sealing surfaces

14 linkage system

15 axial direction

16 radial direction

17 plate spring

1-9. (canceled)

10. The wastegate assembly (5) for an exhaust gas turbocharger having a turbine housing, comprising:
a wastegate flap (5a);
a wastegate flap lever (5c);
a wastegate spindle (5b);
a bearing bush (7) for the wastegate spindle; and
a seal (11, 17) which is formed by a volumetric sealing ring (11) and a plate spring (17) in contact with the volumetric sealing ring (11), wherein the bearing bush (7) has a widening section (7a) arranged in the end region, which faces the wastegate flap lever (5c), of the bearing bush (7),
wherein
the volumetric sealing ring comprises soft material and is pressed into the widening section (7a) of the bearing bush (7a);
a radial bias is present between the wastegate spindle (5b) and the bearing bush (7); and
the plate spring (17) is positioned between the volumetric sealing ring (11) and the wastegate flap lever (5c).

11. The wastegate assembly according to claim 10, wherein the volumetric sealing ring (11) comprises soft material in which one or more support layers are layered.

12. The wastegate assembly according to claim 10, wherein the plate spring (17) consists of a material with high temperature resistance.

13. The wastegate assembly according to claim 10, wherein the turbine housing (1) has a receiving step (1b) into which the widening section (7a) of the bearing bush (7) is inserted.

14. The wastegate assembly according to claim 10, further comprising a volumetric sealing ring (11) in the end region, which is remote from the wastegate flap lever (5c), of the bearing bush (7).
